(19) United States
(12) Patent Application Publication
(10) Pub. No.: US 2015/0278955 A1
(43) Pub. Date: Oct. 1, 2015

(54) SECURITY TRANSACTION SERVICE METHOD USING COMPANY MONEY

(71) Applicant: Jung Guem KIM, Gangnam-gu Seoul (KR)

(72) Inventor: Jung Guem Kim, Seoul (KR)

(21) Appl. No.: 14/434,778

(22) PCT Filed: Oct. 10, 2013
(86) PCT No.: PCT/KR2013/009066

§ 371 Date: Apr. 10, 2015

(30) Foreign Application Priority Data
Oct. 12, 2012 (KR) 10-2012-0113643

(51) Int. Cl. G06Q 40/06

(52) U.S. Cl. CPC G06Q 40/06; G06Q 40/025

(57) ABSTRACT

Disclosed herein is a security transaction service method using company money. In the security transaction service method, when a security collection request is received from a security beneficiary, security providers to provide loaned money to the security beneficiary using a time deposit as a security are collected. When the collection of the security providers is completed, loaned money loaned using a time deposit provided as a security as a security is provided to the security beneficiary, and company money is received from the security beneficiary at the cost of a security transaction. The company money is distributed to each of the security providers, and the security providers purchase goods or services of the security beneficiary using the distributed company money.

### TECHNICAL FIELD

The present invention relates to a financial service based on a security transaction.

More particularly, the present invention relates to a security transaction service method, using company money, of recruiting security providers that want to receive the reward of security provision as the company money depending on a security transaction request of a security beneficiary and allowing a security transaction to be made between the security beneficiary and the security providers.

### BACKGROUND ART

An enterprise (including a company) or a nation raises funds through financial institutions.

For example, an enterprise raises funds by providing a security, giving a surety, or issuing corporate bonds, and a nation raises funds by issuing national bonds.

A nation may also complete specific business using private capital.

However, it is difficult for the enterprise to rapidly receive a loan from financial institutions as desired. Particularly, the lower the prominence of an enterprises is, the more difficult it is to receive a loan.

In addition, enterprises having low prominence receive loans at a relatively high interest rate and must issue corporate bonds at a high interest rate compared with a well-known enterprise, and the case in which a purchase of the corporate bonds does not smoothly occur when the enterprises having the low prominence issue the corporate bonds frequently occurs.

Further, since start-up enterprises or small enterprises do not have prominence or security and may not issue corporate bonds, it is substantially impossible for them to raise funds from financial institutions.

As a result, in the case in which the start-up enterprises or the small enterprises use the financial institutions, concrete reliability indicators such as a high credit score, capability of providing a security, presence of a sale, a high sale, or the like, should be secured in order to raise the funds from the financial institutions.

### DISCLOSURE

### Technical Problem

The present invention has been made in an effort to provide a security transaction service method using company money having advantages of contracting a security transaction with a general person based on confidence of an enterprise to secure funds and providing the company money at the cost of the security transaction.

Further, the present invention has been made in an effort to provide a security transaction service method using company money having advantages of allowing both of an enterprise and a security provider to share a profit with each other by replacing a cost depending on a security transaction by a company money issuing rate that is higher than a deposit interest rate.

### Technical Solution

An exemplary embodiment of the present invention provides a security transaction service method using company money.

The security transaction service method includes: a first step in which a security transaction server receives a security collection request from a first security beneficiary and registers the security collection request in a security transaction request list; a second step in which the security transaction server provides the security transaction request list to a customer; a third step in which the security transaction server provides a security collection content (including company information, a company money payment rate, and a company money issuing rate) suggested by the first security beneficiary selected by the customer in the security transaction request list to the customer; a fourth step in which the security transaction server registers the customer approving a security transaction as a security provider of the first security beneficiary and establishes a security of the security provider as a security; a fifth step in which the security transaction server repeats the second to fourth steps until a loaned amount of money loaned using the security of the security provider becomes an amount of money requested by the first security beneficiary; a six step in which the security transaction server establishes the security of the recruited security beneficiary as the security and provides loaned money depending on the security establishment to the first security beneficiary, when the security collection corresponding to the first security beneficiary is completed; a seventh step in which the security transaction server generates company money corresponding to company money payment reserves for the loaned money when the security transaction server receives the company money payment reserves from the first security beneficiary and distributes the company money to each of accounts of the security providers; and an eighth step in which the security transaction server subtracts used company money from a fund for company money of a security provider using the company money when the security transaction server receives use information of the company money from an external apparatus.

### Advantageous Effects

According to the present invention, funds may be raised based on reliability of an enterprise without being received directly from a financial institution, making it possible to allow a small enterprise to raise funds through only reliability of a product, business activity, a technology, or the like.

In addition, according to the present invention, an enterprise, a nation, a self-governing body, or the like provides company money, thereby making it possible to predict demand for products and to obtain a higher pecuniary benefit as compared with the case of providing funds by raising the interest rate, and a security provider receives the company money having a higher benefit (or interest rate) than a deposit interest rate, thereby making it possible to receive a higher pecuniary benefit than a time deposit.

### DESCRIPTION OF THE DRAWINGS

FIG. 1 is a view for describing a first concept of the present invention.

FIG. 2 is a view for describing a second concept of the present invention.

FIG. 3 is a network configuration diagram for a security transaction service method using company money according to an exemplary embodiment of the present invention.

FIG. 4 is a block diagram of a security transaction server according to an exemplary embodiment of the present invention.

FIG. 5 is a data flowchart showing a security transaction service method using a company money according to a first exemplary embodiment of the present invention.

FIG. 6 is a data flowchart showing a security transaction service method using company money according to a second exemplary embodiment of the present invention.

FIG. 7 is a data flowchart showing a security transaction service method using company money according to a third exemplary embodiment of the present invention.

FIG. 8 is a data flowchart showing a method of using and extinguishing company money generated depending on the security transaction service method using company money according to an exemplary embodiment of the present invention.

### MODE FOR INVENTION

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive.

Like reference numerals designate like elements throughout the specification.

Hereinafter, a security transaction service method using company money according to an exemplary embodiment of the present invention will be described in detail with reference to the accompanying drawings.

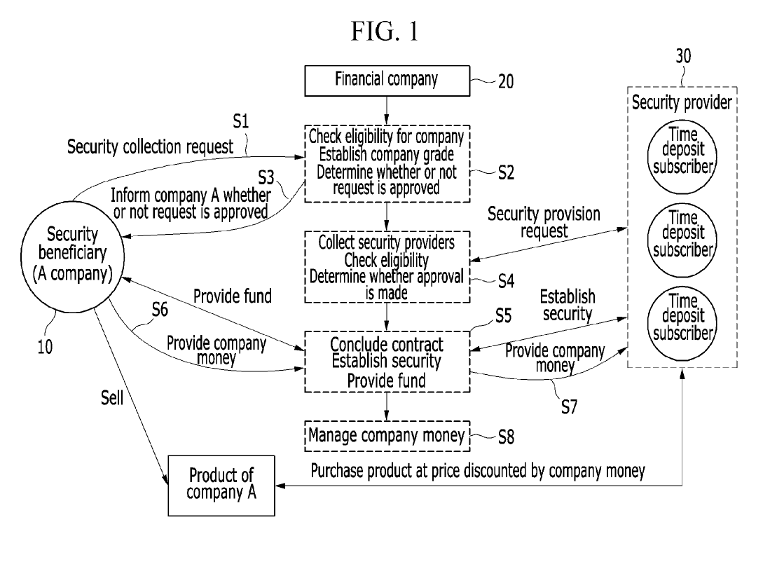

FIG. 1 is a view for describing a first concept of the present invention.

Before describing the present invention, main terms according to the present invention will be described.

A security beneficiary, which is one receiving loaned money with security of a security provider, is, for example, an enterprise or a nation (or a self-governing body).

A security provider, which is one permitting a loan on security with a security-provided security, is, for example, a general person, an enterprise, a nation, or a self-governing body.

A middleman, which is one performing security establishment for the security provided by the security provider and providing loaned money, is, for example, a bank, a banking investment firm, or the like.

The security includes a time deposit, negotiable securities, real rights obtained by way of security such as real estate, and certification of payment such as a guarantee.

Hereinafter, the case in which a security is a time deposit will be described in order to assist in understanding.

Company money is electronic money for the reward of security provision, and is electronic money corresponding to a loan interest amount of money for loaned money provided at the cost of the security of the security provider.

The company money is generated and managed by the middleman, and when the middleman receives loan interest (that is, cash) for loaned money from the security beneficiary, the middleman stores and manages the loan interest, generates the company money corresponding to the loan interest amount of money, and provides the company money to the security provider.

When the company money is used, the company money is exchanged with cash by the middleman to settle the cash for one holding the company money, and is extinguished after the settlement.

Here, the cash for settling the company money is subtracted from the loan interest amount of money stored by the middleman.

In addition, the company money is used at the time of purchasing goods or services, but may be exchanged for cash.

The company money is exchanged for cash depending on a company money payment rate at the time of being exchanged for cash.

The company money payment rate is a rate in which the company money is exchanged for cash. For example, when the company money payment rate is 100%, the entirety of the loan interest amount of money stored by the middleman is provided as cash, and when the company money payment rate is 10%, 10% of the loan interest amount of money is provided as cash.

The company money is electronic money for the cost of security provision.

As an example, when the security provider provides 10,000 won as a security to the security beneficiary for one year and a company money issuing rate is 10%, company money generated after one year is 1000 won.

At the time of purchasing a product worth 5000 won sold by the security beneficiary using the company money of 1000 won generated as described above, the security provider pays the sum of the company money of 1000 won and his/her money of 4000 won as a purchase price to purchase the product.

As another example, in the case of paying predetermined company money as a purchase price of a product A (product of a company A), there is a method of providing a discount rate of a set percentage of a price of the product A.

As a specific example, a security collection content of company A (that is, a security beneficiary), which is a construction company, at the time of collecting a security is as follows: “a company money issuing rate is 8% per year, and an apartment may be purchased at a price discounted by 10% in the case in which a company money of twenty million won is paid as a purchase price in purchasing an apartment of about 105 m² or less as a method of using the company money”.

Therefore, when the security provider provides fifty million won as a security for the company A for five years in a preparation period (eight years) for purchasing the apartment, the security provider receives four million won corresponding to 8% (company money issuing rate) of fifty million won as company money every year, such that he/she receives company money of a total of twenty million won for five years.

In addition, when it is assumed that the company A sells an apartment of about 105 m² at a price of three hundred million won and sells an apartment of about 79 m² at a price of two hundred million won after eight years, the security provider may provide the company money of twenty million won to the company A to purchase the apartment of about 105 m² at a price of two hundred seventy million won discounted from three hundred million won by 10% and purchase the apartment of about 79 m² at a price of one hundred eighty million won discounted from two hundred million won by 10%.

A magnitude of the company money provided to the security provider is determined depending on a magnitude of a security amount of money provided as a security and a loan period.

For example, the larger the security amount of money and the longer the loan period, the larger the company money.

Hereinafter, the magnitude of the company money provided to the security provider will be called a company money issuing rate.

The present invention will be described below based on the main terms according to the present invention as described above.

As shown in FIG. 1, a security transaction service method using company money according to an exemplary embodiment of the present invention is a security transaction server method of allowing a security transaction to be made between a security beneficiary 10 and a security provider 30 through a financial company 20 such as a bank, a savings bank, or the like, which is a middleman, and paying the company money to the security provider 30 at the cost of security provision.

In FIG. 1, the security beneficiary is called “company A” by way of example in order to assist in the understanding.

The company A 10 requiring a fund makes a security collection request to the financial company 20 (S1).

The security collection request is to request the company A 10 to recruit the security provider.

The security collection request includes an amount of money required by the company A 10, company information on the company A 10, compensation information of security provision (that is, an issuing rate and a payment rate of company money provided to the security provider, a method of using the company money, or the like), information on a funds use period (including the expiration date), and the like.

Here, the company information on the company A 10, which is information informing the security provider of reliability of the security beneficiary 10, is information informing the security provider of financial soundness, a technology level, or market competitiveness of the company, excellence of a product produced by the company, or the like.

The company information on the security beneficiary 10 is a main factor in determining whether the security provider makes a security transaction with the company A 10.

The company information on the company A 10 may be created by the company A 10 itself and may be provided to the financial company 20, or may be created by an institution performing evaluation for the financial company 20 or the company A 10.

When the financial company 20 receives the security collection request, the financial company 20 checks eligibility of the company A 10 making the security collection request (eligibility for security collection), determines a company credit grade, establishes a security limit, and determines whether or not the security collection request is approved depending on the eligibility (S2).

Here, the eligibility is checked by determining whether the company A 10 is included in a stored enterprise list, and enterprises included in the enterprise list stored in a storing medium (for example, a database) of the financial company 20 are enterprises with which the security transaction may be made.

Company credit grades are established for each of the enterprises included in the enterprise list, and the financial company 20 determines a company credit grade of the enterprise making the security collection request.

The company credit grade is used as an element for determining an issuing rate of company money to be provided to the security beneficiary at the time of a security transaction.

For example, in the case in which a suggested issuing rate of the company money is lower than a set interest rate depending on the company credit grade even though the company credit grade is low, such that reliability is low, it is determined that the company is ineligible for a security transaction.

Meanwhile, in the case in which the company A 10 is not included in the stored enterprise list (hereinafter referred to as “eligible enterprise list”) in the check for the eligibility, the financial company 20 determines whether the company A 10 is included in an enterprise list of enterprises classified as ineligible (hereinafter referred to as “ineligible enterprise list”), and reserves the security collection request until the company A 10 is registered in one of the eligible enterprise list and the ineligible enterprise list when the company A 10 is not included in the ineligible enterprise list.

The registration of the company A 10 in one of the eligible enterprise list and the ineligible enterprise list is accomplished in a scheme in which the eligibility for the company A 10 is checked by a professional and the company A 10 is classified by the professional and is stored by a storing medium.

When an eligible or ineligible result for the company A 10 is registered, the financial company 20 again starts a reserved eligibility check to check the eligibility for the company A 10 depending on registered information.

When the company A 10 is an eligible enterprise and suggested company money is a set reference or more, the financial company 20 approves security collection and informs the company A 10 of an approval result (S3).

At the same time, the financial company 20 publishes the security collection of the company A 10 on the Internet to recruit the security provider (S4).

In S4, the financial company 20 provides information related to the security collection of the company A 10 to the security provider 30 making a security provision reading request, and the security provider 30 confirms the information on the company A 10 included in the information related to the security collection, an issuing rate of company money, and a payment rate of the company money to determine whether or not a security provider provides a security.

Here, the issuing rate of the company money and the payment rate of the company money are determined by the security beneficiary, that is, the company A 10.

The financial company 20 checks eligibility for the security provider determining security provision.

Here, the eligibility is checked by confirming whether or not the security provider holds a time deposit that is to be provided as a security, an eligible qualification to determine security provision behavior is checked, and the financial company 20 approves the security provision and informs the security provider 30 of the approval, in the case in which the security provider 30 holds the time deposit.

The financial company 20 repeats a process of S4 to secure a plurality of security providers that are to provide the security, and completes the security collection when a total sum of secured time deposits becomes a security amount of money requested by the company A 10.

When the financial company 20 completes the security collection, the financial company 20 allows a contract for the security transaction between the company A 10 and the security provider 30 to be concluded, and when the contract is concluded, the financial company 20 establishes security for the time deposit of the security provider, loans funds at the cost of the security establishment, and provides the funds to the company A 10.

When the company A 10 receives the funds, the company A 10 provides loan interest to the financial company 20 according to a contract content. Therefore, the financial company 20 generates company money corresponding to a loan interest amount of money, and the security provider receives company money of a rate corresponding to an amount of money and a provision period of the time deposit provided by the security provider in company money of the company A 10 managed by the financial company 20 (S7).

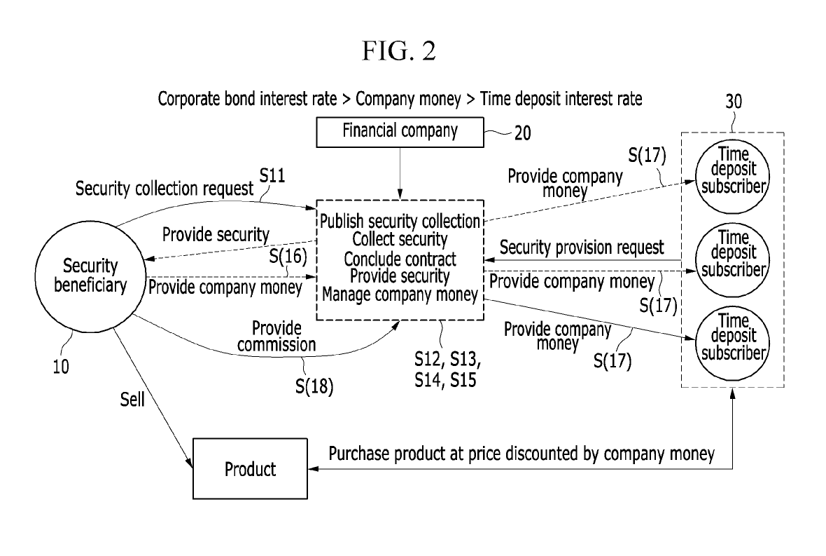

FIG. 2 is a view for describing a second concept of the present invention.

The first concept of the present invention described above with reference to FIG. 1 relates to the case in which the financial company 20, which is a security transaction middleman, provides eligibility for the company A 10 to a customer while ensuring the eligibility to some degree, while a second concept of the present invention that will be described with reference to FIG. 2 relates to a case in which the security provider determines investment eligibility for the company A 10 by itself.

That is, the second concept of the present invention is that an investor determines whether or not he/she makes a security transaction for the company A 10, that is, whether he/she makes an investment, by only evaluating reliability of the company A 10 by himself/herself. In the second concept, S2 in the first concept is omitted.

In addition, a company in this case may be an individual or any organization in addition to an enterprise, a nation, or a self-governing body.

In detail, the company A 10 requiring funds makes a security collection request to the financial company 20 (S11).

Here, the security collection request includes an amount of money required by the company A 10, company information on the company A 10, compensation information of security provision (that is, information on an issuing rate and a payment rate of a company money provided to the security provider, a method of using the company money, or the like), information on a fund use period (including the expiration date), and the like.

When the financial company 20 receives the security collection request, the financial company 20 publishes the security collection request of the company A 10 on the Internet (S12).

In addition, the financial company 20 provides information related to the security collection of the company A 10 to the security provider 30 making a security provision reading request, and the security provider 30 confirms the information on the company A 10 included in the information related to the security collection, an issuing rate of company money, a payment rate of the company money, a method of using the company money, and the like, to determine whether or not he/she will provide a security, and recruit a customer determining a security provision intention to be a security provider (S13).

In addition, the financial company 20 checks eligibility for the customer determining security provision.

Here, the eligibility is checked by confirming whether or not the customer holds a time deposit that is to be provided as a security, an eligible qualification to determine security provision behavior is checked, and the financial company 20 approves the security provision and informs the security provider 30 of the approval, in the case in which the customer holds the time deposit.

The financial company 20 publishes the security transaction until the security collection is completed to secure a plurality of security providers that are to provide the security, and completes the security collection when a total sum of secured time deposits becomes a security amount of money requested by the company A 10.

When the financial company 20 completes the security collection, the financial company 20 allows a contract for the security transaction between the company A 10 and the security provider 30 to be concluded (S14), and when the contract is concluded, the financial company 20 establishes a security for the time deposit of the security provider, loans funds at the cost of the security establishment, and provides the funds to the company A 10 (S15).

When the company A 10 receives the funds, the company A 10 provides funds depending on a company money payment rate to the financial company 20 according to a contract content to request the financial company 20 to manage the company money (S16), and the security provider receives company money at a rate corresponding to an amount of money and a period of the time deposit provided by the security provider in company money of the company A 10 managed by the financial company 20 (S17).

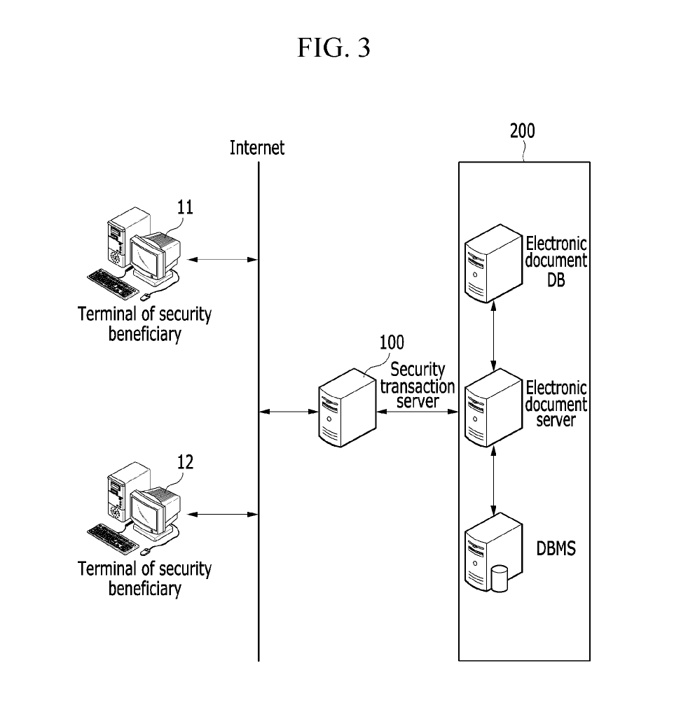

Next, a network configuration according to an exemplary embodiment of the present invention will be described with reference to FIG. 3.

FIG. 3 is a network configuration diagram for a security transaction service method using company money according to an exemplary embodiment of the present invention.

As shown in FIG. 3, a network for the security transaction service method using company money according to an exemplary embodiment of the present invention is configured to include a security beneficiary terminal 11, a security provider terminal 12, a security transaction server 100, and a financial system 200.

The security beneficiary terminal 11, which is a terminal managed by an enterprise making a security transaction request, is a terminal that may access the Internet, and the security provider terminal 12, which is a terminal used by one providing a security, is also a terminal that may access the Internet.

The financial system 200 is a general financial system built-up by a financial institution for the purpose of various financial tasks, that is, a legacy system of the financial institution.

The security transaction server 100 is the Internet server operated by a banking sector, a non-banking sector, or the like, is built-up on the Internet, is connected to the security beneficiary terminal 11 and the security provider terminal 12 through the Internet, and is connected to the financial system 200 through the Internet or an internal dedicated communication network.

The security transaction server 100 is an apparatus providing a security transaction service using company money according to the first or second concept of the present invention.

Main functions of the security transaction server 100 will be described. The security transaction server 100 receives a security transaction request from a security beneficiary, registers security transaction content depending on the security transaction request, and publishes the registered security transaction content.

In addition, the security transaction server 100 recruits a security provider through the publication of the security transaction content, determines a time deposit of the security provider, and establishes the time deposit as a security to provide funds required by the security beneficiary to the security beneficiary using the time deposit of the security provider as the security.

Further, the security transaction server 100 provides contract content so that a formal security transaction contract may be made between the security beneficiary and the security provider, and registers and manages a contract document at the time of making the contract.

Further, the security transaction server 100 receives funds depending on a company money payment rate included in the contract content from the security beneficiary in the case in which the security transaction contract is completed, and distributes and manages the funds to the security provider in proportion to an amount of money provided as the security.

Further, in the case in which the security beneficiary uses the company money, the security transaction server 100 receives information indicating that the security beneficiary uses the company money online, pays an amount of money remaining after subtracting the used company money from the funds depending on a company money payment rate of a corresponding security beneficiary to the security beneficiary, and sets off a difference between the funds depending on the company money payment rate and the company money from a purchase and sale price between the security beneficiary and the security provider.

The security transaction server 100 pays the funds depending on the company money payment rate to the security provider, and the financial company takes over the company money from the security provider.

Here, since an amount of company money is generally larger than an amount of money calculated by the company money payment rate, a company operating the security transaction server 100 may have a pecuniary benefit in the case in which it utilizes the company money of the corresponding security provider.

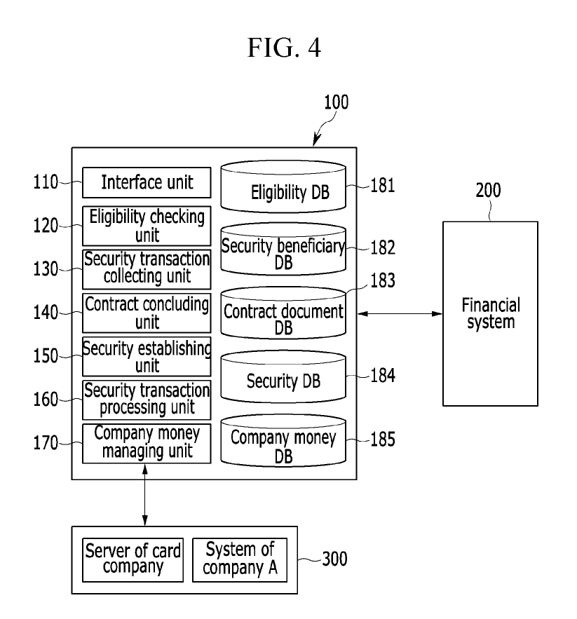

FIG. 4 is a block diagram of a security transaction server according to an exemplary embodiment of the present invention, and shows a security transaction server according to the first concept of the present invention.

Here, the security transaction server according to the second concept of the present invention excludes the eligibility checking unit 120.

As shown in FIG. 4, the security transaction server 100 according to an exemplary embodiment of the present invention is configured to include an interface unit 110, an eligibility checking unit 120, a security transaction collecting unit 130, a contract concluding unit 140, a security establishing unit 150, a security transaction processing unit 160, a company money managing unit 170, an eligibility database (DB) 181, a security beneficiary DB 182, a contract document DB 183, a security DB 184, and a company money DB 185.

The interface unit 110 includes a first interface that is in charge of an interface with the Internet, and a second interface that is in charge of an interface with a bank common network (or local network).

The first interface supports communication between the security beneficiary terminal 11 and the security provider terminal 120, and the second interface supports communication with the financial system 200.

The eligibility checking unit 120 checks security transaction eligibility of the security beneficiary 10 making a security collection request.

The security transaction eligibility is checked using the stored eligible enterprise list and ineligible enterprise list.

The eligibility checking unit 120 determines a grade of the security beneficiary 10 making the security collection request when the security beneficiary 10 is an eligible enterprise, determines whether or not a security transaction interest rate or company money suggested in content of the security collection request accords with the grade, and performs approval processing in the case in which the security transaction interest rate or the company money accords with the grade.

Here, the eligibility checking unit 120 establishes a range of a security transaction volume and a range of a company money issuing rate depending on the grade, and the lower the grade, the lower the eligibility, such that an interest rate is increased (or more company money is issued), and the higher the grade, the higher the eligibility, such that the interest rate is decreased (or less company money is issued).

The eligibility checking unit 120 requests the security transaction collecting unit 130 to perform security collection when the eligibility of the security beneficiary 10 making the security collection request is approved.

The security transaction collecting unit 130 registers the security beneficiary 10 making the security collection request in a security transaction request list, registers a security transaction collection content (for example, company information, a company money payment rate, a company money issuing rate, the expiration date, and the like) of the corresponding security beneficiary, and publishes the security transaction collection content at the time of being requested by an accessor.

In addition, the security transaction collecting unit 130 confirms whether or not one making a security provision request among accessors subscribes to a time deposit and has an eligible qualification to determine security provision behavior to determine whether one asking the security has a qualification of a security provider, recruits one asking to provide the security as the security provider in the case in which one asking to provide the security has the qualification, and ends the security collection for the corresponding security beneficiary 10 when a time deposit corresponding to an amount of money requested by the security beneficiary 10 is collected.

Meanwhile, the security transaction collecting unit 130 supports an inter-enterprise security transaction.

The inter-enterprise security transaction is a continuous security transaction between a first enterprise making an inter-enterprise security collection request and a second enterprise making an inter-enterprise security provision request. Here, the first enterprise is an enterprise making a security loan using a time deposit as a security through the security transaction collecting unit 130 to receive the security from the second enterprise.

The security transaction collecting unit 130 registers the enterprises making the inter-enterprise security transaction request in an inter-enterprise security request list, publishes this information to the enterprises making the inter-enterprise security provision request, and collects the enterprises to provide the security.

The contract concluding unit 140 provides a contract document between the security beneficiary 10 and the security provider 30 with respect to a security transaction request of which the security collection ends to allow a contract to be concluded therebetween, and stores and manages a concluded contract document.

Here, a content of the contract document depends on a security transaction collection content provided by the security beneficiary 10.

The security establishing unit 150 accesses the financial system 200 through the interface unit 110, establishes time deposit existence, which is security of the security provider 30, as the security in association with the financial system 200, and stores and manages a security establishment content.

In addition, the security establishing unit 150 allows a loan depending on the security establishment to be made in association with the financial system 200 when the security establishment for the security is completed.

The security transaction processing unit 160 provides loaned money depending on the request of the security beneficiary to the security beneficiary 10 when the security establishment is completed, requests the security beneficiary 10 to settle the security transaction on the expiration date, and terminates the time deposit established as the security when the security transaction is settled.

The company money managing unit 170 generates company money corresponding to company money payment reserves (that is, loan interest) when the company money payment reserves are received from the security beneficiary 10, and distributes and manages the generated company money for each security provider 30.

Here, the distribution is different in grades depending on an amount of money (that is, an amount of money of the time deposit) provided by the security provider 30 and a period.

The company money managing unit 170 is connected to a server 300 of a card company or a system of the security beneficiary 10 to receive a use breakdown of the company money used by the security provider from the server of the card company, and provides an amount of money obtained by subtracting the used company money from the company money of the security provider 30 depending on the use breakdown to the card company.

The eligibility DB 181 stores an eligible enterprise list, an ineligible enterprise list, and information on company credit grades of each enterprise of the eligible enterprise list therein, and ranges of company money payment rates and security deposit collection amounts of money for each company grade are set in the eligibility DB 181.

The security beneficiary DB 182 stores various information on the security beneficiary 10 therein, and the contract document DB 183 may store the contract document concluded between the security beneficiary 10 and the security provider 30 therein.

In addition, the security DB 184 stores information on the time deposit established as the security for each security transaction therein.

The company money DB 185 stores each company money provided for each security transaction therein separately for each security provider.

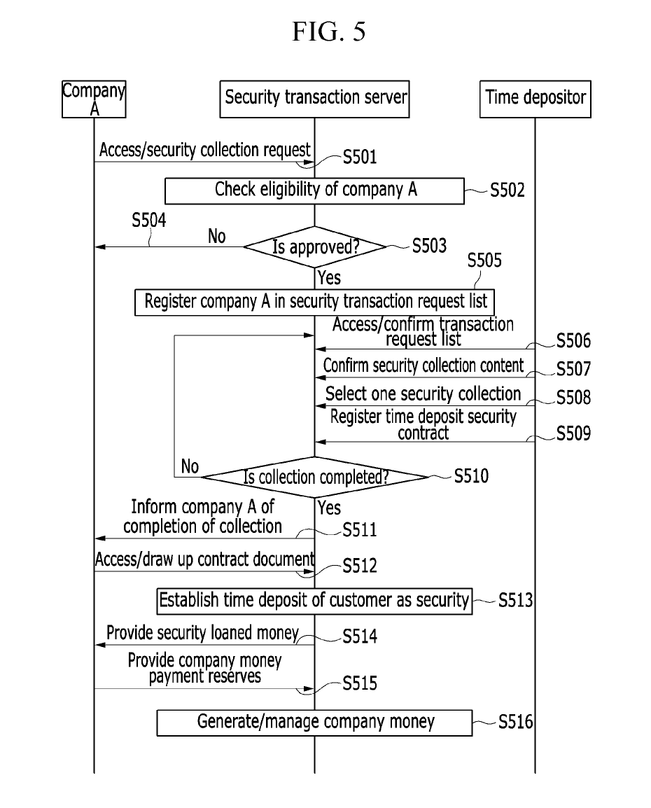

Next, a security transaction service method using company money according to an exemplary embodiment of the present invention will be described with reference to FIGS. 5 to 8.

FIG. 5, which is a data flowchart showing a security transaction service method using company money according to a first exemplary embodiment of the present invention, shows an example of implementing the first concept of the present invention.

As shown in FIG. 5, the security beneficiary accesses the security transaction server 100 using the terminal 11 and makes a security collection request (S501).

Here, the company A 10 provides information such as a security collection amount of money, company information, a security transaction period (including the expiration date), a company money payment rate, a company money issuing rate, and the like, to the security transactions server 100 at the time of making a security collection request.

The security transaction server 100 performs an eligibility check on the company A 10 making the security collection request using information stored in the eligibility DB 181 to decide whether the company A 10 is a company with which the security transaction may be made and whether a company money payment rate and a company money issuing rate suggested at the time of the security transaction are eligible for a company credit grade (S502).

The security transaction server 100 approves the eligibility check (S503) in the case in which soundness (reliability) of the company A 10 and a content of the security transaction are eligible, and informs the company A 10 of security collection request cancellation (S504) in the case in which it does not approve the eligibility check.

When the security transaction server 100 approves the eligibility check, the security transaction server 100 registers the company A in a security transaction request list, and also registers a security transaction content in the security transaction request list (S505).

A time depositor 30 accesses the security transaction server 100 using the terminal 12 to make a request for confirmation of the security transaction request list (S506), and receives the security transaction request list from the security transaction server 100 (S506).

The time depositor 30 selects a security transaction of interest in the security transaction request list and receives and confirms information on a company of corresponding security collection and a security collection content from the security transaction server 100 (S507).

Next, the time depositor 30 selects one of the confirmed security collections and makes a security provision request to the security transaction server 100 (S508).

Therefore, the security transaction server 100 confirms whether the time depositor 30 holds a time deposit and has an eligible qualification to determine security provision behavior through an eligibility check for the time depositor 30 making the security provision request, and approves the security provision when the time depositor 30 has the eligible qualification and cancels the approval when the time depositor 30 does not hold the time deposit.

In the case in which the security transaction server 100 approves the security provision, the security transaction server 100 concludes a time deposit security contract with the time depositor 30 through a set procedure, stores identification information of the corresponding security provider and information of a time deposit account providing the security in the security beneficiary DB 182, and registers the concluded contract document in the contract document DB 183.

When the security contract is concluded, the security transaction server 100 determines whether a collected security amount of money of the corresponding security collection becomes a security collection amount of money requested by the company A 10, and continuously performs the security collection when the collected security amount of money is not sufficient and completes the security collection (S510) when the collected security amount of money is sufficient.

When the security collection is completed, the security transaction server 100 informs the company A 10 of the completion of the security collection (S511), and draws up a contract document for the security transaction with the company A 10 and stores the drawn-up contract document in the contract document DB 183 (S512).

Next, the security transaction server 100 establishes a security with respect to the time deposit of the security provider 30, matches the time deposit to identification information of the security collection, and stores information of the time deposit account established as the security in the security DB 184 (S513).

When the security establishment is completed, the security transaction server 100 provides a security loaned money requested by the company A 10 to the company A 10 (S514) to receive company money payment reserves from the company A 10 (S515).

When the security transaction server 100 receives the company money payment reserves, the security transaction server 100 generates company money corresponding to the company money payment reserves, distributes the company money to each security provider 30, and stores and manages distribution information in the company money DB 185 (S516).

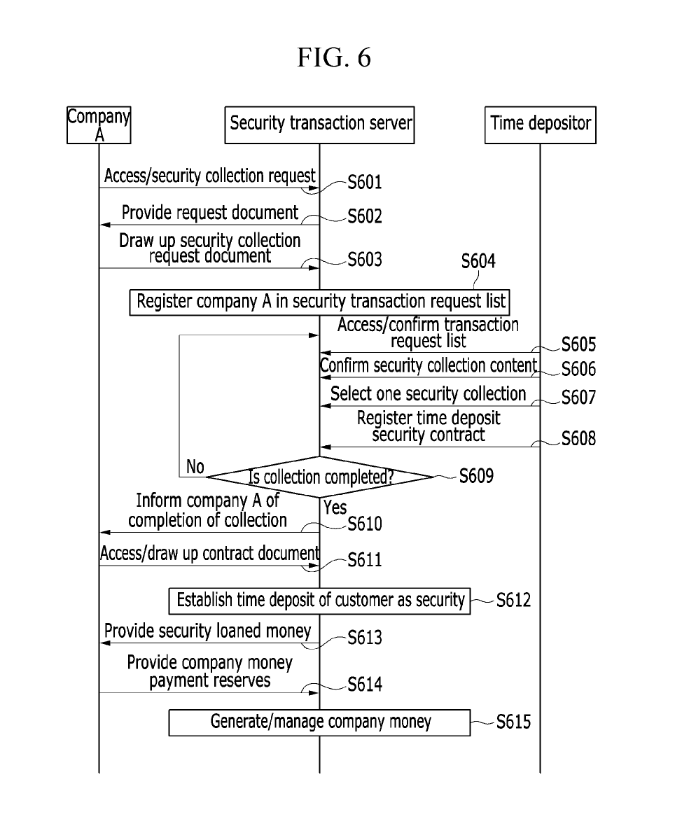

FIG. 6, which is a data flowchart showing a security transaction service method using a company money according to a second exemplary embodiment of the present invention, shows an example of implementing the second concept of the present invention.

As shown in FIG. 6, the security transaction service method using company money according to a second exemplary embodiment of the present invention is substantially similar to the security transaction service method using company money according to a first exemplary embodiment of the present invention. However, the security transaction service method using company money according to the second exemplary embodiment of the present invention is different from the security transaction service method using company money according to the first exemplary embodiment of the present invention in that an eligibility check for the security beneficiary making the security collection request, that is, the company A 10, is not performed.

The meaning that the eligibility check for the security beneficiary 10 is not performed is that it is determined completely by a decision of the security provider 30 whether or not the security for the security beneficiary 10 is provided, that is, it is determined whether or not the security transaction is made based on only reliability of the security beneficiary 10.

Since the security transaction service method using company money according to the second exemplary embodiment of the present invention shown in FIG. 6 is the same as the security transaction service method using company money according to the first exemplary embodiment of the present invention except that the eligibility check for the company A 10 is omitted, a detailed description thereof will be omitted.

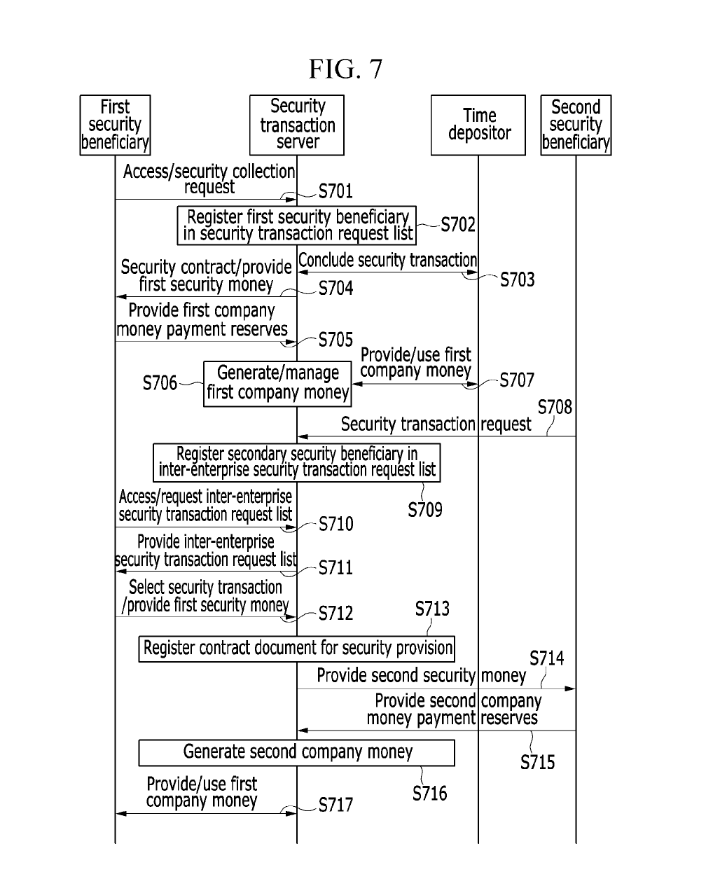

FIG. 7, which is a data flowchart showing a security transaction service method using company money according to a third exemplary embodiment of the present invention, shows the case in which a first security beneficiary makes a loan using a time deposit received as a security from a second security beneficiary as a security to again provide a security.

Here, the first security beneficiary has a higher company credit grade than an enterprise providing funds.

In the following description, a security transaction service method using company money according to the second concept of the present invention will be described.

As shown in FIG. 7, the first security beneficiary accesses the security transaction server 100 using the terminal 11 and makes a security collection request (S701).

Therefore, the security transaction server 100 registers the first security beneficiary in a security transaction request list and also registers a security transaction content in the security transaction request list (S702).

A time depositor 30 accesses the security transaction server 100 using the terminal 12 to confirm the security transaction request list, selects a security transaction of interest, and receives and confirms information on a company of corresponding security collection and a security collection content from the security transaction server 100.

Next, the time depositor 30 selects one of the confirmed security collections and makes a security provision request to the security transaction server 100, and the security transaction server 100 approves security provision for the time depositor 30 of which eligibility is confirmed through an eligibility check for the time depositor 30 making the security provision request and concludes a contract with the time depositor 30 (S703).

When the security contract is concluded, the security transaction server 100 determines whether a collected security amount of money of the corresponding security collection becomes a security collection amount of money requested by the first security beneficiary, and continuously performs the security collection when the collected security amount of money is not sufficient and completes the security collection when the collected security amount of money is sufficient.

When the security collection is completed, the security transaction server 100 informs the first security beneficiary of the completion of the security collection, draws up a contract document for the security transaction with the first security beneficiary, and then establishes a security for a time deposit of the security provider 30 to provide loaned money corresponding to an amount of money required by the first security beneficiary to the first security beneficiary (S704).

Therefore, the first security beneficiary provides company money payment reserves corresponding to an amount of money specified on the contract document to the security transaction server 100 (S705), and the security transaction server 100 generates company money corresponding to the company money payment reserves and distributes the company money to each security provider 30 (S706).

The security transaction server 100 performs management so as to subtract a used amount of money in the case in which first company money is used by the security provider (S707).

Meanwhile, the second security beneficiary accesses the security transaction server 100 using the terminal and makes an inter-enterprise security collection request (S708).

The inter-enterprise security collection is collection behavior for receiving security loaned money from another enterprise.

The enterprise making the inter-enterprise security collection request receives security loaned money from another enterprise making an inter-enterprise security provision request.

The security transaction server 100 registers the secondary security beneficiary making the inter-enterprise security collection request in an inter-enterprise security transaction request list and stores and manages a security collection content (S709).

Meanwhile, the first security beneficiary receiving the security loaned money depending on the security transaction accesses the security transaction server 100 to make an inter-enterprise security provision request (S710), and receives the inter-enterprise security transaction request list (S711).

The first security beneficiary 10 confirms enterprises registered in the inter-enterprise security transaction request list and making the security collection request and security provision information and then selects the second security beneficiary, and provides all or some of the first security money to the security transaction server 100 (S712).

The security transaction server 100 concludes a contract for the security transaction with the first security beneficiary providing the security and registers a contract document (S713).

When a security money provided by the first security beneficiary corresponds to an amount of money requested by the second security beneficiary, the security transaction server 100 completes the inter-enterprise security collection. However, when the security money provided by the first security beneficiary is less than the amount of money requested by the second security beneficiary, the security transaction server 100 continuously performs the inter-enterprise security collection.

When the security money provided by the first security beneficiary corresponds to the amount of money requested by the second security beneficiary, the security transaction server 100 concludes a security contract with the second security beneficiary and then provides second security money (that is, the amount of money requested by the second security beneficiary) to the second security beneficiary (S714).

Therefore, the second security beneficiary provides second company money payment reserves corresponding to the second security money to the security transaction server 100 (S715), and the security transaction server 100 generates company money corresponding to the second company money payment reserves and distributes the company money to each enterprise providing the security (S716).

In addition, the security transaction server 100 performs management so as to subtract a used amount of money in the case in which the second company money is used by the first security provider (S717).

Meanwhile, although the first company money has been provided to the security provider providing the time deposit as the security, in the case in which the security beneficiary providing the first company money receives the second company money from another enterprise, some or all of the first company money may be replaced by the second company money under approval of the security provider.

Meanwhile, as a method of allowing the security provider to use the company money, there are a direct using method, a method of using a card, and the like.

The direct using method is a method in which the security provider informs that he/she is the security provider and receives a confirmation that he/she is the security provider to purchase the product or purchase the product at a discount price, in a store selling a product.

The method of using a card is a method of registering a store selling a product manufactured by the security beneficiary as a member store of a card company, receiving a card that may use company money, issued from the card company, providing the card to the security provider, and then allowing company money provided to the security provider to be reflected as card payment money when the security provider uses the corresponding card in the corresponding member store.

A method of using the company money follows a direct payment card payment scheme or a credit card payment scheme depending on whether the card provided to the security provider is a direct payment card or a credit card.

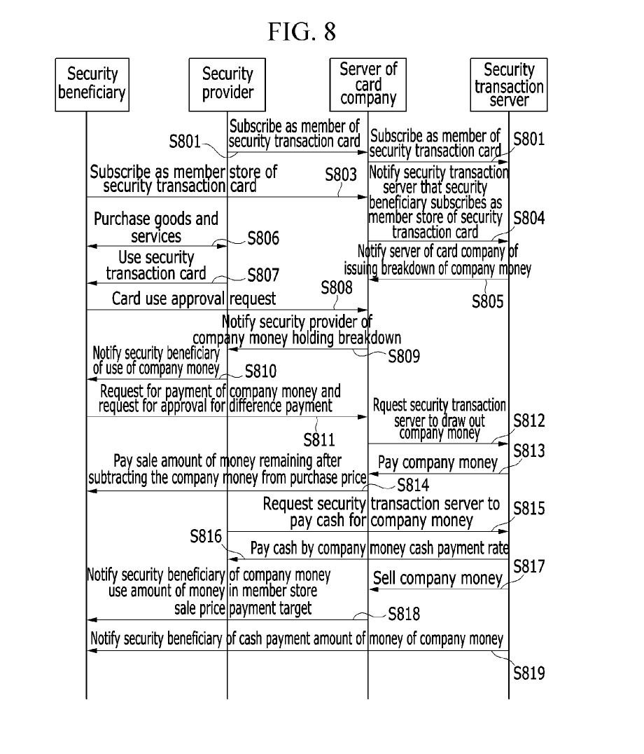

Next, as an example, the case in which the security provider uses company money using a card will be described with reference to FIG. 8.

FIG. 8 is a data flowchart showing a method of using and extinguishing company money generated depending on the security transaction service method using company money according to an exemplary embodiment of the present invention.

As shown in FIG. 8, the security provider subscribes as a member of a security transaction card, and thus a server of a card company registers and manages the security provider as the member of the security transaction card (S801).

Then, the server of the card company notifies the security transaction server 100 that the security provider is a member of the security transaction card (S802).

The security beneficiary registers a member store of the security transaction card, and thus the server of the card company registers and manages a store, an online shopping mall, and the like, of the security beneficiary as the member store of the security transaction card (S803). Then, the server of the card company notifies the security transaction server 100 that the security beneficiary is a member store of the security transaction card (S804).

Then, the security transaction server 100 provides issuing breakdown information of company money issued by the corresponding security beneficiary to the server of the card company (S805).

In this state, the security provider visits the store of the security beneficiary or accesses the online shopping mall of the security beneficiary to purchase goods or services of the security beneficiary (S806).

Then, when the security provider makes a card payment request to the security beneficiary in order to pay a purchase price using a card (S807), the security beneficiary makes a card use approval request to the server of the card company (S808).

The server of the card company provides company money holding breakdown information to the security provider (S809), and the security provider confirms company money held by him/her and then requests the security beneficiary to pay the purchase price using all or some of the company money (S810).

The security beneficiary makes a request for payment of the corresponding company money and card payment approval for a difference depending on the request of the security provider (S811).

The server of the card company requests the security transaction server 100 to draw out the company money (S812).

The security transaction server 100 provides the company money of the corresponding security provider to the server of the card company depending on the request for drawing out the company money (S813), and the server of the card company performs payment for an amount of money remaining after subtracting the company money from the purchase price (S814).

Meanwhile, in the case in which the security provider holds company money that is not used and does not purchase the goods or the services of the security beneficiary, the security provider requests the security transaction server 100 to pay cash for the company money (S815).

Therefore, the security transaction server 100 exchanges the company money held by the security provider with cash and pays the cash, depending on a company money cash payment rate (S816).

The security beneficiary requests the financial company (that is, the security transaction server) to pay the cash, and the financial company may sell the obtained company money to the card company in response to the request (S817).

In this case, the card company buys the company money to extinguish the company money as an amount of money corresponding to a security transaction card sale amount of money of the security beneficiary (S818), and the company money that is not sold may be withdrawn from a company money managing account to thereby substitute for the cash provided to the security provider (S819).

The exemplary embodiments of the present invention described above are not implemented through only apparatuses and methods, but may also be implemented through a program executing functions corresponding to configurations of the exemplary embodiments of the present invention or a recording medium in which the program is recorded. In addition, these implementations may be easily made by those skilled in the art to which the present invention pertains from the exemplary embodiments described above.

Although the exemplary embodiments of the present invention have been described in detail hereinabove, the scope of the present invention is not limited thereto. That is, several modifications and alterations made by those skilled in the art using a basic concept of the present invention as defined in the claims fall within the scope of the present invention.

1. A security transaction service method, comprising:
a first step in which a security transaction server receives a first security collection request including a security collection content (including company information, a required amount of money, a company money payment rate, and a company money issuing rate) transmitted from a terminal of a first security beneficiary and registers the first security collection request in a security transaction request list;
a second step in which the security transaction server provides the security transaction request list depending on a request of a terminal of a customer;
a third step in which the security transaction server provides the first security collection request selected by the terminal of the customer in the security transaction request list to the terminal of the customer;
a fourth step in which the security transaction server registers the customer as a security provider of the first security beneficiary and establishes a security of the security provider as a security, when the security transaction server receives a security transaction approval for the security collection request from the terminal of the customer;
a fifth step in which the security transaction server repeatedly performs the second to fourth steps to recruit security providers of the first security beneficiary, until a loaned amount of money loaned using the security provided by the registered security provider of the first security beneficiary becomes a required amount of money of the security collection content;
a six step in which the security transaction server establishes the security of the security provider as the security to generate loaned money and provide the loaned money to an account of the first security beneficiary;
a seventh step in which the security transaction server generates company money corresponding to an amount of money of a loan interest when the security transaction server receives the loan interest for the loaned money and distributes the company money to each of accounts of the security providers; and
an eighth step in which the security transaction server subtracts used company money from a fund for company money of a security provider using the company money when the security transaction server receives use information of the company money from an external apparatus.

2. The security transaction service method of claim 1, wherein the first step includes a process of determining eligibility for the first security beneficiary or a content of the first security collection request when the first security collection request is received from the terminal of the first security beneficiary, and in the case in which the eligibility for the first security beneficiary or the content of the first security collection request is approved, the first security collection request is registered in the security transaction request list.

3. The security transaction service method of claim 1, wherein the fourth step includes a process of determining eligibility for the customer approving the security transaction, and in the case in which the eligibility for the customer is approved, the customer is registered as a security provider.

4. The security transaction service method of claim 3, further comprising a ninth step in which the security transaction server concludes a contract for a security transaction with the customer registered as the security provider and stores a contract content.

5. The security transaction service method of claim 4, further comprising a tenth step in which the security transaction server concludes a contract for a security transaction with the first security beneficiary and stores a contract content.

6. The security transaction service method of claim 5, wherein the company money is used to purchase goods or services sold by the first security beneficiary.

7. The security transaction service method of claim 6, wherein the company money issuing rate is determined depending on a magnitude of an amount of money of a security and a security period of the security.

8. The security transaction service method of claim 6, further comprising an eleventh step in which the security transaction server exchanges company money of the security provider with funds depending on a company money payment rate and provides the funds, when the security transaction server receives a cash payment request for the company money from a terminal of the security provider.

9. The security transaction service method of claim 1, wherein the external apparatus is a server or an apparatus managed by the first security beneficiary or a server managed by a card company.
